(19) United States
(12) Patent Application Publication
(10) Pub. No.: US 2009/0039031 A1
(43) Pub. Date: Feb. 12, 2009

(54) Controlling the formation of hexavalent chromium during an oxidative remediation of a contaminated site

(75) Inventors: Douglas C. Gustafson, Antioch, CA (US); Reid H. Bowman, Ojai, CA (US)

Correspondence Address: King & Spalding LLP, P.O. Box 889, Belmont, CA, 94002-0889, US

(73) Assignee: Applied Process Technology, INC., Pleasant Hill, CA (US)

(21) Appl. No.: 12/217,355

(22) Filed: Jul. 2, 2008

Related U.S. Application Data
(60) Provisional application No. 60/947,571, filed on Jul. 2, 2007.

(51) Int. Cl. B09C 1/08; C02F 1/72; C02F 1/78

(52) U.S. Cl. 210/747; 405/128.5

(57) ABSTRACT

A method for inhibiting formation of hexavalent chromium during oxidative remediation of a contaminated site containing trivalent chromium is described. The method comprises introducing ozone at a first point to the contaminated site, where the ozone is introduced at a first frequency and for a first period of time, and introducing hydrogen peroxide to the contaminated site, where the hydrogen peroxide is introduced at a second frequency and for a second period of time. The first and second frequencies and first and second periods of time are selected to inhibit formation of hexavalent chromium within the site of remediation.

### PRIORITY

The present application claims priority to U.S. Provisional Application No. 60/947,571, filed on Jun. 2, 2007, which is hereby incorporated by reference in its entirety.

### TECHNICAL FIELD

The subject matter described herein relates to a method for inhibiting formation of hexavalent chromium during an oxidative remediation of a contaminated site containing trivalent chromium.

### BACKGROUND

The chemical contamination of groundwater and subsurface soil continues to be a complex issue, the resolution of which challenges the regulatory community, property owners, remediation experts and environmental technologists. There are an estimated 217,083 contaminated sites in the United States (U.S.) alone that require some form of remediation to remove potential threats to groundwater resources. Furthermore, the preservation of water resources is a daunting challenge, due to the escalating number of recognized contaminated groundwater sites and increased demands for consumer good.

Stricter environmental regulations, the identification of new groundwater contaminants, increasing concern over public health, increasing demand for limited groundwater resources, and the need to restore valuable land space, have all placed a greater demand for the implementation of effective remedial technologies for groundwater restoration. With over 1.2 million underground storage tanks at an estimated 400,000 facilities that may be leaking according to of U.S. Environmental Protection Agency (EPA) studies, the use of more aggressive, cost-effective clean-up technologies is necessary if our degraded aquifers are to be restored in a timely manner.

Emerging in-situ technologies utilizing advanced oxidation processes are being pursued as a way to provide efficient and cost-effective solutions to the restoration of chemically-degraded groundwater and subsurface soil. For example, U.S. Pat. No. 6,284,143 describes a system that injects oxidants in the form of microbubbles that oxidize and remove the contaminants. U.S. Patent Publication No. 2005/0067356 describes (i) the injection of an oxidant into a contaminated site followed by injection of a compressed gas to distribute the oxidant through the contaminated site, and (ii) the optional injection of second oxidant. Each of these documents is incorporated herein by reference in its entirety.

However, the problem remains that chromium that is naturally present in soil (and groundwater) can be oxidized to hexavalent chromium. Chromium is a naturally occurring element found in rocks, animals, plants, soil, and the like. The most common forms of chromium are chromium(0), chromium(III), and chromium(VI). Chromium(III) is the naturally-occurring form of chromium, while chromium(0) and chromium(VI) are industrial products. Chromium(0) is used for making steel, while chromium (III) and chromium(VI) can be used for chrome plating, dyes, pigments, leather tanning, and as wood preservatives. Various forms of chromium can attach strongly to soil with a small amount dissolving in rain or irrigation water to contact ground water.

Although chromium(III) is an essential nutrient, chromium(VI) is a health hazard. Breathing and ingesting chromium(VI) can cause nosebleeds, skin and stomach ulcers, holes in the nasal septum, convulsions, kidney and liver damage, and even death. Chromium(VI) has been observed to cause birth defects in animals an is suspected of causing birth defects in humans (see, e.g., Agency for Toxic Substances and Disease Registry, Toxicological Profile for Chromium, Atlanta, Ga.; U.S. Department of Health and Human Services, Public Health Service; ATSDR (2000)). Accordingly, methods for remediating contaminated soil while controlling the oxidation of chromium into hexavalent chromium are needed.

### SUMMARY

In one aspect, a method for inhibiting formation of hexavalent chromium during an oxidative remediation of a contaminated site containing trivalent chromium is provided. The contaminated site can contain a soil and a groundwater. In some embodiments, the method comprises introducing ozone at a first point to the contaminated site, where the ozone is introduced at a first frequency and a first period of time; and introducing hydrogen peroxide to the contaminated site, where the hydrogen peroxide introduced at a second frequency and a second period of time. The first and second frequencies and first and second periods of time can be selected to inhibit formation of hexavalent chromium at a distance of at least about 10 feet from the first point such that the amount of hexavalent chromium present in the contaminated site after remediation is less than about 50 μg/L.

In some embodiments, the method comprises injecting a series of doses of ozone into the contaminated site, where the injecting can include a pulsating ozone cycle through one or more ozone injection points, and the doses of ozone are in amounts that do not exceed the ozone oxidation equivalent of organics in the contaminated site; injecting a series of doses of hydrogen peroxide into the contaminated site, where the injecting includes a pulsating peroxide cycle through one or more peroxide injection points. The doses of hydrogen peroxide are in amounts that exceed the ozone oxidation equivalent of organics in the contaminated site. In these embodiments, the pulsating ozone cycle and the pulsating peroxide cycle are independent cycles, the pulsating ozone cycle having independently selected ozone injection periods and independently selected periods between ozone injections, and the pulsating peroxide cycle having independently selected peroxide injection periods and independently selected periods between peroxide injections. Neither the ozone injection periods nor the peroxide injection periods typically exceed about 60 minutes each in duration, in some embodiments. The distances between the ozone injection points and peroxide injection points allow for a portion of the ozone to contact at least a portion of the hydrogen peroxide to create hydroxyl radicals. The amount of hexavalent chromium present in the contaminated site at a distance of at least about 10 feet from any ozone injection point after remediation is preferably less than about 50 μg/L.

In some embodiments, the method further comprises injecting air or another inert gas into the contaminated site. In some embodiments, the method further comprises injecting oxygen into the contaminated site. In some embodiments, the method further comprises measuring the ozone oxidation equivalent of the organics during the remediation of the contaminated site.

In some embodiments, the pulsating ozone cycle and the pulsating peroxide cycle overlap and are alternating in a random manner. In some embodiments, the pulsating ozone cycle and the pulsating peroxide cycle overlap and are alternating in a fixed manner. In some embodiments, the ozone injection periods include an ozone injection period ranging from about 5 minutes to about 15 minutes. In some embodiments, the peroxide injection periods include a peroxide injection period ranging from about 5 minutes to about 15 minutes. In some embodiments, the injecting of ozone is at a flow rate of about 4 g/hr to about 40 g/hr of ozone in a gas comprising oxygen. In some embodiments, the injecting of hydrogen peroxide is at a flow rate of about 1 to about 10 gallons/day of about 2 to about 20% hydrogen peroxide

In some embodiments, the method further comprises measuring the amount of hexavalent chromium present at points in the contaminated site before remediation, during remediation, and/or after remediation of the contaminated site. In some embodiments, the amount of hexavalent chromium present at a distance of at least about 10 feet from any ozone injection point is less than about 20 μg/L after the remediation.

In addition to the exemplary aspects and embodiments described above, further aspects and embodiments will become apparent by reference to the drawings and by study of the following descriptions.

### BRIEF DESCRIPTION OF THE DRAWINGS

FIG. 1 illustrates an injector for use in injecting the ozone and hydrogen peroxide into a contaminated site, according to some embodiments.

FIGS. 2A and 2B illustrate the screen slot openings at injection points for use in injecting the ozone and hydrogen peroxide into a contaminated site, according to some embodiments. FIG. 2A shows a drawing, while FIG. 2B shows and image.

FIG. 3 is a representative cross-section of a typical remediation site, according to some embodiments.

FIG. 4 illustrates a non-limiting example of a matrix of injection wells mapped out in a contaminant plume, according to some embodiments.

### DETAILED DESCRIPTION

The apparatus and methods relate to inhibiting the formation of hexavalent chromium during oxidative remediation of a contaminated site/region containing trivalent chromium. The contaminated site can contain soil and groundwater.

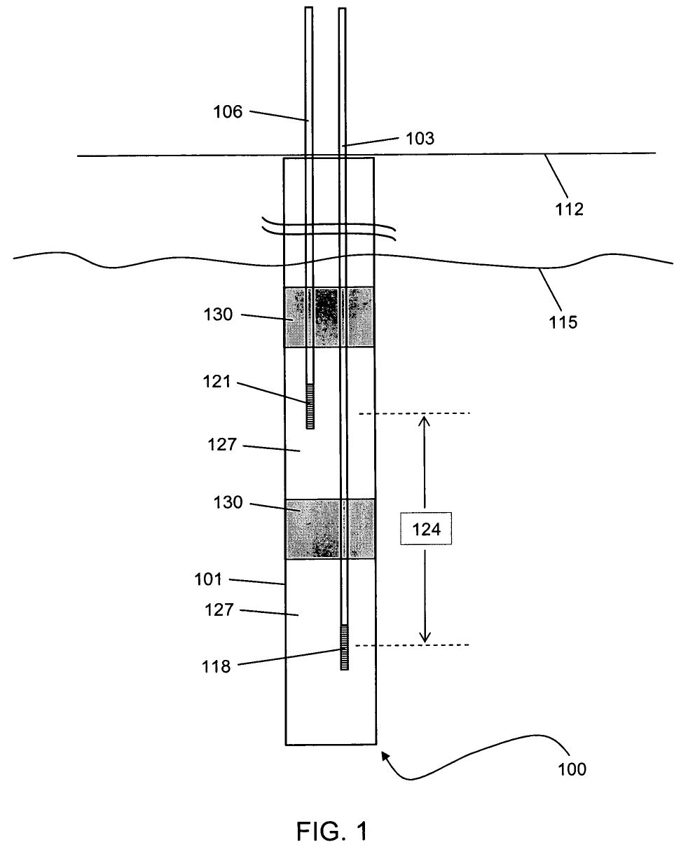

An exemplary apparatus is illustrated in FIG. 1. The figure shows an injector 100 for use in injecting the ozone and hydrogen peroxide into a contaminated site. The level of the soil 112 and groundwater 115 are indicated. The injector 100 is adapted to inject gas and liquid oxidants through delivery conduits 103, 106 to contaminated soil or groundwater. In some embodiments, the gas oxidant includes ozone and the liquid oxidant includes hydrogen peroxide. The ozone may be introduced into the contaminated site in the form of ozone in oxygen gas or ozone in an oxygen-enriched air stream. Injection of the gas oxidant may be followed by injection of another gas, such as air, nitrogen, oxygen, or a combination thereof. Similarly, injection of the liquid oxidant may be followed by a injection of a gas, such as air, nitrogen, oxygen, or a combination thereof.

The injector 100 may have a gas oxidant injection point 118 located downstream of a gas oxidant conduit 103 and a liquid oxidant injection point 121 located downstream of a liquid oxidant conduit 106. In some embodiments, the liquid oxidant injection point 121 is positioned above the gas oxidant injection point 118. The distance 124 between the gas oxidant injection point 118 and the liquid oxidant injection point 121 can range from about 6 inches (in) to about 6 feet (ft), for example, from about 1 ft to about 5 ft, from about 2 ft to about 4 ft, about 3 ft, and any range therein.

The apparatus 100 can be located in a well or casing 101; however, injection points 118, 121 can be in direct contact with contaminated soil and water, and do not require a casing or other container 101. According, the terms “injector,” “injector well,” and “injection well” may used interchangeably to refer to the present injector apparatus. In some embodiments, the gas oxidant injection point 118 and/or the liquid oxidant injection point 121 are encased in sand 127, which may be naturally present or added to a remediation site. Particularly where the injector 100 is provided in a well or casing, a Bentonite seal can be used to separate and seal the region above the liquid oxidant injector, as well as between the liquid oxidant injection point 121 and the gas oxidant injection point 118.

The present methods may begin, for example, by injecting ozone in an amount of from about 0.5 to about 10% (wt/wt) in oxygen into the groundwater through gas oxidant conduit 103. Ozone injection can be stopped after application of a selected dose of ozone or when the groundwater surrounding the ozone injection point is saturated with ozone. Air can than be injected, e.g., to force ozone-containing groundwater through channels, such as pores and voids, in the soil. Such channels may be formed by the process of injecting ozone and/or air into the groundwater.

A liquid oxidant, e.g., hydrogen peroxide can be injected through a gas oxidant conduit 106. The concentration of the hydrogen peroxide can range from about 5% to about 35% by weight. One of skill will appreciate that, in some embodiments, the amount of liquid oxidant injected (e.g., H₂O₂) can be dependent on the amount of ozone injected. Subsequent to injection of the liquid oxidant, air may be injected to facilitate movement of the groundwater containing the liquid oxidant hydrogen peroxide through-channels in the soil, as in the case of the gas injection.

Upon injection, gas and liquid oxidants, such as ozone and hydrogen peroxide, come into contact and react to form hydroxyl radicals that react with the contaminants in the soil and/or groundwater. Such hydroxyl radicals are typically formed at a depth corresponding to the distance 124 between the gas injection point 118 and liquid injection point 121. Forcing air through the gas and liquid conduits assist in distributing the oxidants and promotes the formation of hydroxyl radicals.

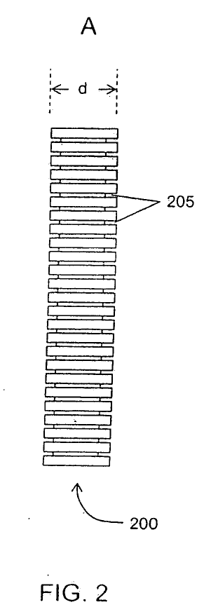

In some embodiments, the gas and/or liquid oxidant injection points 118, 121 are in the form of screens that allow the passage of gas or liquid but prevent the influx of soil, sand, and other particulate matter. FIGS. 2A and B illustrates an exemplary type of slotted screen for use in injecting the ozone and hydrogen peroxide into a contaminated site. This embodiment uses a commercially available slotted screen 200 having continuous 0.02 in slotted openings 205. One of skill will appreciate that the screen slot openings 205 may be larger or smaller depending on gas volume and geological constraints. The gas oxidant injection point 118 and liquid oxidant injection point 121 may use similar size openings 205. The length of the screen 200 used at the injection points 118, 121 can vary, and typically range from about 6 in to about 6 ft, from about 1 ft to about 5 ft, from about 2 ft to about 4 ft, about 3 ft, and any range therein, in order to provide an adequate gas and liquid flow. In other embodiments, screens with holes, rather than slots are used.

In some embodiments, the method comprises introducing ozone at a first point to the contaminated site, where the ozone is introduced at a first frequency and a first period of time; and introducing hydrogen peroxide to the contaminated site, where the hydrogen peroxide introduced at a second frequency and a second period of time. The first and second frequencies and first and second periods of time can be selected to inhibit formation of hexavalent chromium at a distance of at least about 10 feet from the first point, such that the amount of hexavalent chromium present in the contaminated site after remediation is less than about 50 μg/L.

The frequencies and time periods may be selected to provide a desired amount of oxidant per injection at each injection point and/or to provide a desired total amount of oxidant that is introduced into the contaminated site in given period of time. The first and second frequencies can be fixed or random and correspond to the number of occurrences within a given time period that an oxidant is introduced into the contaminated site.

The frequency of introducing a gas oxidant may independent of the frequency of introducing a liquid oxidant. That is, the frequency of providing a gas oxidant can be the same as, or different than, the frequency of providing a liquid oxidant. The frequency can be fixed, meaning that the same frequency is repeated throughout the remediation of the contaminated site. Alternatively, the frequency can be variable, meaning the frequency is not fixed, but rather can vary throughout the remediation of the contaminated site. The frequency can also be random.

The frequency of introducing an oxidant into the contaminated site can range, for example, from about 30 seconds to about 30 hours, from about 5 minutes to about 5 hours, from about 10 minutes to about 10 hours, from about 15 minutes to about 15 hours, from about 20 minutes to about 20 hours, or any range therein. In some embodiments, the frequency of injection can range from about 1 minute to about 1 hour, from about 3 minutes to about 3 hours, from about 5 minutes to about 30 minutes, or any range therein. In some embodiments, the injection frequency can be 5, 10, 15, 20, or 25 minutes. The duration of a given injection can also be fixed or variable, and can range from about 1 minute to about 1 hour, from about 3 minutes to about 3 hours, from about 5 minutes to about 30 minutes, or any range therein. In some embodiments, the duration of injection can be 5, 10, 15, 20, or 25 minutes. One of skill will appreciate that the injection periods and periods between injections can be independently designed and selected for both the gas and liquid oxidant injections, and can be independently designed and selected to be fixed, variable, random, or a combination thereof.

In some embodiments, the method comprises injecting a series of doses of ozone into the contaminated site, where the injecting can include a pulsating ozone cycle through one or more ozone injection points, and the doses of ozone can be, for example, in amounts that do not exceed the ozone oxidation equivalent of organics in the contaminated site; injecting a series of doses of hydrogen peroxide into the contaminated site, where the injecting includes a pulsating peroxide cycle through one or more peroxide injection points.

The doses of hydrogen peroxide may be, for example, in amounts that exceed the ozone oxidation equivalent of organics in the contaminated site. In these embodiments, the pulsating ozone cycle and the pulsating peroxide cycle may be independently selected cycles, the pulsating ozone cycle having independently selected ozone injection periods and independently selected periods between ozone injections, and the pulsating peroxide cycle having independently selected peroxide injection periods and independently selected periods between peroxide injections. These independently selected cycles can be the same or different between cycles and between the first and second oxidant such as, for example, the gas and the liquid oxidant.

In some embodiments, neither the ozone injection periods nor the peroxide injection periods exceed about 60 minutes in duration. The distances between the ozone injection points and peroxide injection points should allow for at least a portion of the ozone and a portion of the hydrogen peroxide to come into contact in the contaminated site to react to create hydroxyl radicals. The amount of hexavalent chromium present in the contaminated site at a distance of at least about 10 feet from any ozone injection point should be less than about 50 μg/L after the remediation. In some embodiments, the amount of hexavalent chromium present in a contaminated site after remediation is less than about 50 μg/L, about 45 μg/L, about 40 μg/L, about 35 μg/L, about 30 μg/L, about 25 μg/L, about 20 μg/L, about 15 μg/L, about 10 μg/L, about 5 μg/L, or any range therein, at a distance of at least about 12 ft, about 10 ft, about 8 ft, about 6 ft, about 4 ft, about 2 ft, or any range therein, from any ozone injection point and/or from any hydrogen peroxide injection point.

In some embodiments, the method further comprises injecting air, oxygen, or a combination thereof, into the contaminated site, either together with a first and/or second oxidant, or separately from the oxidants. The separate injection of air and/or oxygen can be used to help distribute oxidant throughout the contaminated site. In some embodiments, the method further comprises measuring the ozone oxidation equivalent of the organics during the remediation of the contaminated site. The ozone oxidation equivalent can be readily determined by one of skill, and represents a measure of a single location within a contaminated site, a set of locations in a select region of a contaminated site, or a set of locations throughout a contaminated site. The measure, in some embodiments, is simply the amount of ozone required to oxidize the contaminants, and this amount can be determined through an empirical calculation based on known organic components or through a chemical analysis either at the site or in a separate laboratory. In some embodiments, the ozone oxidation equivalent can be used as a relative measure for determining the amount of any oxidant, for example, the amount of ozone and/or hydrogen peroxide to apply to a contaminated site.

The determination of the area in which to estimate the ozone oxidation equivalent can be determined by the design of the process used to remediate the soil. For example, the range within which a given injector can apply the oxidants can sometimes be referred to as a radius-of-influence or a volume of influence, which terms are used synonymously, herein. Accordingly, the design can be such that the samples are taken with the radius of influence to determine the ozone oxidation equivalent for that single injector. Likewise this can be determined for sets of injectors, or for the contaminated site as a whole. The particular design of a remediation plan depends on a variety of factors, such as the amounts of contaminants present, the types of contaminants, the geological characteristics of the contaminated site to be treated, and the like.

In some embodiments, the pulsating ozone cycle and the pulsating peroxide cycle overlap or alternate in a variable or random manner. In some embodiments, the pulsating ozone cycle and the pulsating peroxide cycle overlap or alternating in a fixed manner. The ozone injection periods may range from about 5 minutes to about 15 minutes. The peroxide injection periods may range from about 5 minutes to about 15 minutes. The injection of ozone may be at a flow rate of about 4 g/hr to about 40 g/hr in a gas comprising oxygen. The injection of hydrogen peroxide may be at a flow rate of about 1 to about 10 gallons/day of about 2 to about 20% hydrogen peroxide.

In some embodiments, much larger flow rates of an gas oxidant, such as ozone, are be injected. For example, the flow rates can be up to 200 lb/day, 100 lb/day, 80 lb/day, 60 lb/day, 40 lb/day, 20 lb/day, 10 lb/day, 5 lb/day, or any range therein. Likewise the concentration of the liquid oxidant can increased to 65%, 60%, 55%, 50%, 45%, 40%, 35%, 30%, 25%, and any range therein, of hydrogen peroxide. Of course, doses lower than 25%, such as those ranging from about 1% to about 20%, from about 2% to about 18%, from about 3% to about 15%, from about 5% to about 10%, or any range therein, of hydrogen peroxide can also be used in the remediation process.

The amount of first and second oxidant injection may be determined by making ongoing measurements of ozone oxidation equivalents. The amount of ozone injected may be less than the ozone oxidation equivalent, and the amount of hydrogen peroxide injected may exceed the ozone oxidation equivalent. A first gas oxidant and a second liquid oxidant, can together, or independently, be injected with any carrier gas or combination of gases that do not significantly adversely affect the intended goal of remediation of the contaminated soil. The skilled artisan can readily determine the compatibility of the desired oxidants and select carrier gases and determine whether a significantly adverse effect would be expected. Accordingly the amounts and concentrations of oxidants injected during remediation can be dynamic, in that they are adjusted to ensure inhibition or elimination of the oxidation of metals, such as oxidation of chromium into hexavalent chromium.

In some embodiments, the method further comprises measuring the amount of hexavalent chromium present at points in the contaminated site before remediation, during remediation, and/or after remediation of the contaminated site. In some embodiments, the amount of hexavalent chromium present at a distance of at least about 10 feet from any ozone injection point and/or any hydrogen peroxide injection point after remediation is less than about 20 μg/L.

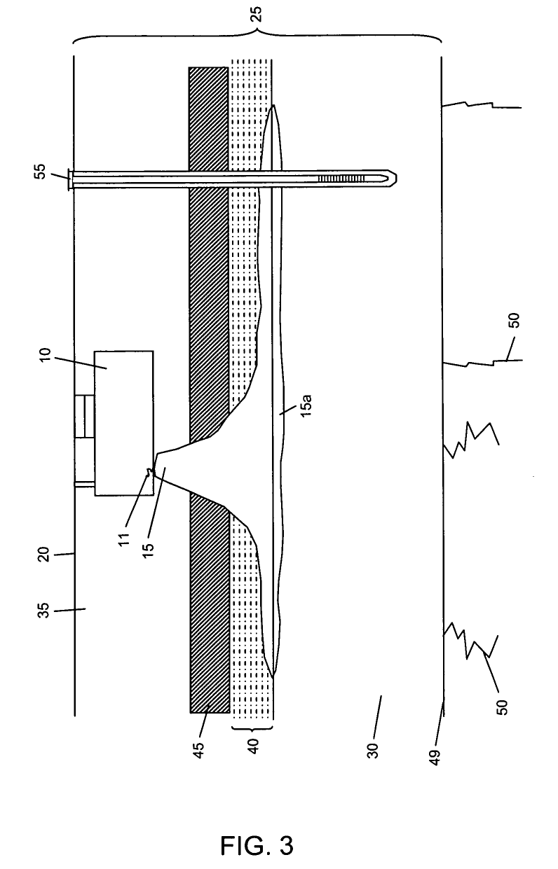

FIG. 3 shows a representative vertical cross-section of a typical remediation site. At this site, an underground storage tank (UST) 10 is shown discharging/leaching contaminants 15 into the surrounding soils and/or groundwater, thereby creating a contaminated region or plume. In this example, leakage is through a crack 11 in the UST 10. The contaminant plume 15, 15a may include a saturated zone, which is typically near the source of the contamination; a smear zone, which typically downstream of the saturated zone; and an unsaturated zone, which is typically most distal to the source of the contamination.

The discharge can impact different areas beneath a ground-level surface 20. The discharge may first contaminate the soil 25, creating free-floating or sinking contamination that eventually contacts and contaminates the groundwater 30. The soil in which the contaminant from the UST 10 comes in contact may be comprised of several different types of soils in layers or strata, for example, sand 35, silt 40, and/or clay 45. Frequently, these different soil layers occur at different depths with respect to the ground-level surface 20.

Remediation sites may include one or more underground strata barriers 49, e.g., formed by naturally occurring geological formations or artificial linings (such as concrete), which act as a barrier to the unconfined migration of the contaminants 15. While such barrier strata 49 may be impervious to the contaminant 15 migration if the strata 49 remains intact, fissures or cracks 50 that in the strata 49 may provide a conduit through which a contaminated plume 15a may extend. Such fissures or cracks 50 may be naturally occurring, the result of earthquakes, the result of penetration of the barrier strata by drilling, and the like.

In a typical in situ remediation process, the process begins with a characterization of the discharged substance(s). Substances which have been discharged to the soil and groundwater can be chemically characterized by a variety of analytical methods, most of which are known in the art. Commonly used analytical methods for chemical characterization of contaminant 15 may include conventional volatile organic analysis (VOA) or BTEX testing, which provides a quantitative determination of benzene, toluene, ethyl benzene, and xylene. Where required, one or more monitoring wells 55 can be drilled/bored beneath the ground-level surface 20 for the purpose of extracting a sample of groundwater 30 in an attempt to identify the contaminant(s) (FIG. 3). Samples of soil 25 and/or groundwater 30 can then be taken from a number of locations throughout the contaminant site for analysis. Where a UST 10 or other container acts as the source of the contamination, a sample can be taken directly from the UST 10 or other container. At other waste sites, the predominant contaminants are well-known, and it is unnecessary to identify the nature of the contaminants.

Once the contaminants 15, 15a have been defined, a three-dimensional model of the contamination site can be prepared and used to estimate the volume and severity of the contamination. The shape and size of the contaminant plume 15,15a are determined by a number of factors, such as (i) the volume of the UST 10 at the time the leak arose; (ii) the nature of the contaminant (e.g., heavy, viscous substances such as hydrocarbon based lubricants); and (iii) the geological characteristics of the soils and water surrounding the UST 10 (e.g., loose, permeable or tightly-packed soils or fast-moving or stagnant aquifer).

Based on such information, the volume of the contamination site and the concentration of contaminants at different locations within the site can be determined, e.g., using calculations that are generally known by those skilled in the art. The quantity of hydrogen peroxide and ozone needed for effective decontamination can be determined based on these calculations or determined empirically. Generally, effective oxidative treatment of a contaminated site requires using a suitable oxidant ratio (i.e., oxidant mass/contaminant mass) to affect removal of the contaminant. Factors impacting the oxidant ratio include the particular groundwater characteristics (i.e., pH, alkalinity, COD, presence of radical scavengers, presence of metals, and the like). Control of bromate formation can be achieved by maintaining a sufficiently high mole ratio of hydrogen peroxide to ozone, for example, in the range of from about 0.5 to about 20.

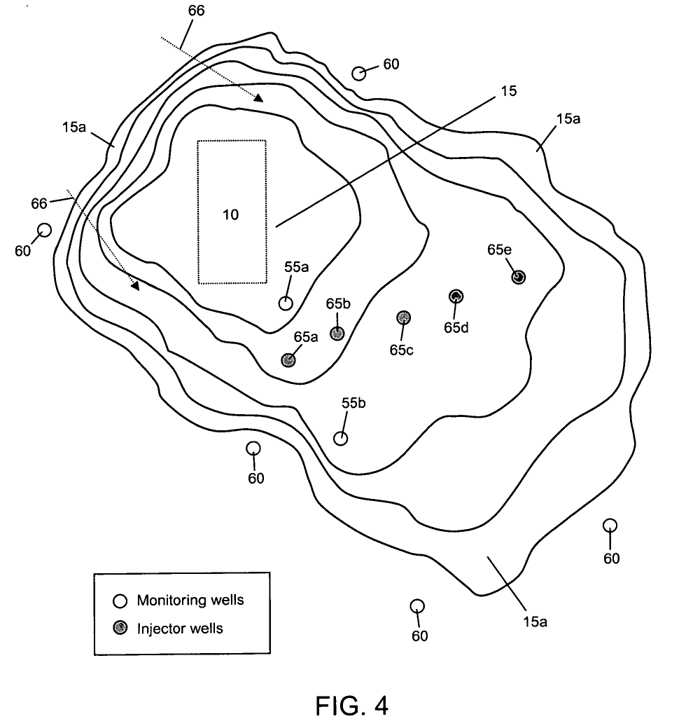

As illustrated in FIG. 4, the contaminant plume 15, 15a can be delineated by boring a number of sentinel wells 60 in an area just outside the contaminant plume 15, 15a and then subsequently performing an analytical characterization of samples taken from these wells. For example, as shown in FIG. 4, sentinel wells 60 lie outside of the contaminant plume 15 while monitoring wells 55 lie within the containment plume 15a. Samples taken from the monitoring wells 55 and the sentinel wells 60 will therefore differ in composition and/or concentration as determined through subsequent analytical testing. After boring a number of the monitoring wells 55 and sentinel wells 60, and characterizing the samples taken from these wells, delineation of the contaminant plume 15 can be determined.

As will be apparent from FIG. 3 and FIG. 4, delineation of the contaminant plume 15, 15a is not limited to any two dimensions. Thus accurate delineation of the boundaries of a contaminant plume 15, 15a may require obtaining and analyzing samples from different monitoring wells 55 and sentinel wells 60, and from different depths in the contaminated sites. The data produced from this analysis may not only characterize the distance that the contaminant plume 15a has migrated, but also can characterize at what depth from the ground-level surface 20 that migration has taken place. Such a characterization is well known in the art as vertical delineation.

The hydrological and geological attributes of the contaminated site can also be characterized to assist in determining the optimal number and position of injection wells 65a-e that are required for installation within the contaminated region (FIG. 4). Such attributes include, e.g., the groundwater flow direction and gradient (see arrows 66); the groundwater characteristics (e.g., mineral content, alkalinity, pH, hardness, and salinity); soil characteristics (e.g., composition of the soil, mineral content, alkalinity, pH, and salinity); soil transmissivity (e.g., soil porosity and soil permeability); and the profile of the geological strata in the contaminated region.

Once the hydrological and geological attributes of the contaminated site are characterized, trials can be conducted to determine the radius of influence (ROI) of a compressed gas continuously sparged into the contaminant plume 15, 15a using standard equipment known in the art. The ROI determines the number and placement of injection wells (i.e., 55 in FIG. 3 and 65a-e in FIG. 4) required to effectively treat the contaminated site. Additionally, trials can be conducted to measure the movement of groundwater in response to pulses of compressed gas in the contaminated plume 15, 15a (i.e., the “dynamic response”) using standard equipment known in the art. Understanding the dynamic response (DR) further permits optimization of the pulse duration and frequency to affect remediation.

Based on the hydrological and geological attributes of the contaminated region and once the ROI and DR have been determined, placement of one or more injection wells 65a-e can be selected such that oxidants are delivered throughout the contaminated site. The injection wells 65a-e may be arranged in a matrix following any arrangement or pattern depending on the shape of the contaminant plume 15,15a. Depending on the size and characteristics of the contaminant plume 15a, as little as one injection well (e.g., 65a) may be used or as many as 100 or more injection wells 65a-e may be used. Where a single injection well (e.g., 65a) is used, the ROI of the injection well should encompass the delineated contamination site. Where multiple injection wells 65a-e are used the ROI of each injection well should overlap, with the overall ROI of the multiple injection wells encompassing the delineated contamination site.

FIG. 4 illustrates a non-limiting example of a matrix of injection wells mapped out in a contaminant plume. In this example, the injection wells 65a-e are spaced about 20 feet apart from each other in a substantially linear pattern within the contaminant plume 15a. A first monitoring well 55a may be provided within the contaminant plume, e.g., about 15 feet upstream (up gradient) from the injection wells 65a-e. A second monitoring well 55b may be provided within the contaminant plume 15, e.g., about 35 feet downstream from the injection wells 65a-e. Monitoring wells 55a, 55b are capable of measuring groundwater characteristics (e.g., pH, dissolved oxygen, dissolved CO₂, oxidative/reductive potential (ORP), and temperature) and contaminant levels.

Note that the terms “up gradient” and “down gradient” refers to the direction in which the distance is measured from the line of ozone injection. The term “up gradient” refers to the distance upstream of the groundwater flow. The term “down gradient” refers to the distance downstream of the groundwater flow.

### EXAMPLES

The following examples are illustrative in nature and are in no way intended to be limiting.

### Example 1

This example shows the control of hexavalent chromium (chromium(VI)) concentrations following oxidative treatment of a contamination site containing methyl tertiary butyl ether (MtBE), tertiary butyl alcohol (TBA), and total petroleum hydrocarbons as gasoline (TPHg). The system ran for an operation period of several months and was surrounded by a “cut-off fence” to prevent migration of the MtBE, TBA, TPHg, and the hydrocarbons.

The cut-off fence included eight ozone injection points and eight hydrogen peroxide injection points that were equally spaced along a 140 foot length. During operation of the system, ozone was injected into the injection wells at a first level and hydrogen peroxide was injected above the level of the ozone. Ozone flow was set at 37 grams per hour in a 23 cubic feet per hour stream of gas containing about 90% oxygen. The gas stream was injected into individual injection points for a fixed time. The ozone was injected continuously in a cycle of injections, such that the ozone was injected as a consecutive series of injections along the eight ozone injection points. After each point received its injection of ozone, the process started over in another cycle of injections. Hydrogen peroxide was injected at a rate of 4.5 gallons per day using 10% hydrogen peroxide and was also injected through individual wells for a fixed time. The hydrogen peroxide injectors could be operated continuously like the ozone injections or could be shut down for one or more cycles. Hydrogen peroxide was injected every other injection cycle, and air was injected following ozone injections. The air could optionally been injected with the ozone.

The ozone was injected for a fixed time ranging from about 8 to about 12 minutes into each injection point, where the injection time was selected based on the type and extent of organic contaminants. The hydrogen peroxide was injected for a fixed time ranging from about 8 to 12 minutes into each hydrogen peroxide injection point to provide a greater than stoichiometric mole ratio, such as, for example, twice (2×) the ozone oxidation equivalent of the organic contaminant can be used. Air was injected after each ozone injection to provide additional distribution of the ozone and hydrogen peroxide.

TABLE 1

| | | Cr⁺⁶ μg/L | |
|---|---|---|---|
| | | During operation | Cr⁺⁶ μg/L |
| Monitoring | | period at | Three months |
| Well | Distance | shutdown | after shutdown |
| MW-20 | 50 ft up gradient | <1 | <1 |
| MW-19 | 12 ft up gradient | 6.5 | 9.3 |
| MW-22 | 10 ft down gradient | 12 | 4.5 |
| MW-23 | 80 ft down gradient | 10 | 11 |
| MW-16 | 120 ft down gradient | 45 | 26 |

Table 1 shows the hexavalent chromium (chromium(VI); Cr⁺⁶) concentrations in samples taken from the indicated monitoring wells during the end of the period of system operation and three months after shut down of the remediation process. Prior to initiating ozone/hydrogen peroxide treatment, the local concentrations of chromium(VI) measured at the sites of the injection wells was well above 1,000 μg/L (not shown). However, the “fence” maintained chromium(VI) levels below 50 μg/L at a distance of at least about 10 feet from the ozone injection points. These observations demonstrate the ability of ozone/hydrogen peroxide treatment to effectively control the amount of chromium(VI) present in the soil and water surrounding a plume.

Samples taken three months after injection of ozone and hydrogen peroxide showed no substantial further increase in the levels of chromium(VI), as would be expected if a high concentration of chromium(VI) remained at the site and spread to surrounding soil and water in the absence of ozone/hydrogen peroxide treatment.

### Example 2

This example illustrates remediation of a contaminated site containing trivalent chromium (chromium(III)), where ozone was introduced below the ozone oxidation equivalent to achieve remediation with inhibition of hexavalent chromium (chromium(VI)) formation. Introduction of ozone was complimented with injection of hydrogen peroxide in a amount that exceeded the ozone oxidation equivalent of organics in the contaminated site.

Three drums were filled with water and soil obtained from an area within a petroleum contamination plume. The chromium(III) present in the groundwater outside of the plume was greater than about 50 ppb. The contents of each of the drums was exposed to ozone and hydrogen peroxide as follows.

Ozone was injected in a series of doses into each drum, where the injecting included a pulsating ozone cycle. The ozone dosing was set to maintain the ozone concentrations in an amount that was below the ozone oxidation equivalent amount of the contaminated samples in the drums. The treatment duration was a several week period, during which time the ozone concentration was maintained below the ozone oxidation equivalent. The injections delivered approximately 4 grams per hour ozone in 23 cubic feet per hour of a gas containing 90% oxygen applied at individual drum injection points. The duration of each ozone injection was 10 minutes with a 30 minute period between injections.

Hydrogen peroxide injections delivered about 1 gallon to about 1.5 gallons per day of about 3% to about 5% hydrogen peroxide. The doses of hydrogen peroxide were selected to exceed the ozone oxidation equivalent of organics in the contaminated samples in the drums through the duration of the treatment period. The hydrogen peroxide was injected into the three individual drums for a fixed injection period of 5, 10, and 15 minutes, respectively.

During and after the treatment cycles, water and soil samples from each drum were taken. The samples were tested using conventional analytical techniques for the concentrations of petroleum contaminate and hexavalent chromium chromium(VI). It is found that formation of hexavalent chromium is inhibited, demonstrating the efficacy of the present apparatus and methods.

While a number of exemplary aspects and embodiments have been discussed above, those of skill will recognize that certain modifications, permutations, additions and sub combinations are possible in light of the teachings herein. One of skill will also appreciate that the teachings provided, therefore, are illustrating general concepts, and will be mindful that there are several variations possible. It is intended that the following claims are to be interpreted in light of the full scope of the possibilities represented by the claims, the associated teachings provided in support of the claims, and the knowledge possessed by one skilled in the art.

What is claimed is:

1. A method for inhibiting formation of hexavalent chromium during an oxidative remediation of a contaminated site containing trivalent chromium, comprising:
introducing ozone at a first point to the contaminated site, said ozone introduced at a first frequency and a first period of time;
introducing hydrogen peroxide to the contaminated site, said hydrogen peroxide introduced at a second frequency and a second period of time;
wherein said first and second frequencies and said first and second periods of time are selected to inhibit formation of hexavalent chromium at a distance of at least about 10 feet from said first point such that the amount of hexavalent chromium present in the contaminated site after remediation is less than 50 μg/L.

2. A method of decreasing the formation of hexavalent chromium during an oxidative remediation of a contaminated site containing a soil and a groundwater, wherein the method comprises:
injecting a series of doses of ozone into the contaminated site, wherein the injecting includes a pulsating ozone cycle through one or more ozone injection points, and the doses of ozone are in amounts that do not exceed the ozone oxidation equivalent of organics in the contaminated site;
injecting a series of doses of hydrogen peroxide into the contaminated site, wherein the injecting includes a pulsating peroxide cycle through one or more peroxide injection points, and the doses of hydrogen peroxide are in amounts that exceed the ozone oxidation equivalent of organics in the contaminated site;
wherein, the pulsating ozone cycle and the pulsating peroxide cycle are independent cycles, the pulsating ozone cycle having independently selected ozone injection periods and independently selected periods between ozone injections, and the pulsating peroxide cycle having independently selected peroxide injection periods and independently selected periods between peroxide injections; and, neither the ozone injection periods nor the peroxide injection periods exceed about 60 minutes each in duration;
wherein, the distances between the ozone injection points and peroxide injection points allow for a portion of the ozone and a portion of the hydrogen peroxide to contact in the contaminated site after injection and react to create hydroxyl radicals;
and wherein, the amount of hexavalent chromium present in the contaminated site at a distance of at least about 10 feet from any ozone injection point is less than 50 μg/L after the remediation.

3. The method of claim 2, wherein the method further comprises injecting air into the contaminated site.

4. The method of claim 2, wherein the method further comprises injecting oxygen into the contaminated site.

5. The method of claim 2, wherein the method further comprises measuring the ozone oxidation equivalent of the organics during the remediation of the contaminated site.

6. The method of claim 2, wherein the pulsating ozone cycle and the pulsating peroxide cycle overlap and are alternating in a random manner.

7. The method of claim 2, wherein the pulsating ozone cycle and the pulsating peroxide cycle overlap and are alternating in a fixed manner.

8. The method of claim 2, wherein the ozone injection periods include an ozone injection period ranging from about 5 minutes to about 15 minutes.

9. The method of claim 2, wherein the peroxide injection periods include a peroxide injection period ranging from about 5 minutes to about 15 minutes.

10. The method of claim 2, wherein the injecting of ozone is at a flow rate of about 4 g/hr to about 40 g/hr in a gas comprising oxygen.

11. The method of claim 2, wherein the injecting of hydrogen peroxide is at a flow rate of about 1 to about 10 gallons/day of about 2 to about 20% hydrogen peroxide.

12. The method of claim 2, wherein the amount of hexavalent chromium present at a distance of at least about 10 feet from any ozone injection point is less than about 20 μg/L after the remedation.

13. The method of claim 2 further comprising measuring the amount of hexavalent chromium present at points in the contaminated site before remediation, during remediation, and after remediation of the contaminated site.
